(19) United States
(12) Patent Application Publication
(10) Pub. No.: US 2025/0003926 A1
(43) Pub. Date: Jan. 2, 2025

(54) SYSTEM AND METHOD OF PULSED EDDY CURRENT TESTING

(71) Applicant: Consolidated Edison Company of New York, Inc., New York, NY (US)

(72) Inventors: Vijayaraghavan Srinivasan, Randolph, NJ (US); Josephine Aromando, Freehold, NJ (US); Yiming Deng, Okemos, MI (US); Xuhui Huang, East Lansing, MI (US)

(21) Appl. No.: 18/756,422

(22) Filed: Jun. 27, 2024

Related U.S. Application Data
(60) Provisional application No. 63/510,481, filed on Jun. 27, 2023.

(51) Int. Cl. G01N 27/90

(52) U.S. Cl. CPC G01N 27/9046

(57) ABSTRACT

A method of pulsed eddy current (PEC) testing includes receiving metal loss output measurements. The metal loss output measurements are calculated based on eddy current response captured by a probe at a location on a pipe or tank, wherein one or more energized high voltage cables are located within the pipe or tank. The method further includes generating compensated metal loss output measurements to compensate for errors in the metal loss output measurements caused by the energized high voltage cables. The method further includes outputting the compensated metal loss output measurements as PEC test results.

### BACKGROUND

The subject matter disclosed herein relates to a system and method of testing pipes and tanks, and in particular to a system and method of testing pipes and tanks containing energized high voltage cables using pulsed eddy current (PEC) testing.

PEC is a nondestructive examination technique which can be used for detecting flaws or corrosion in pipes containing ferrous materials such as carbon steel and cast iron. PEC can be used to provide a relative volumetric measurement converted into an averaged thickness measurement based on the probe size and distance from the probe to the pipe or tank. To generate and capture PEC response, a magnetic field is created by an electrical current, located for example, in one or more coils of a probe. The magnetic field penetrates through the cladding and any non-conductive insulation of the pipe and stabilizes in the component thickness. Then, the emission of the electrical current is cut off. This abrupt change induces pulsed eddy currents that can be captured by the probe and used to calculate an average thickness of the pipe at the location of the probe.

Contemporary equipment that is used to perform PEC testing may include components to perform electronic filtration of electromagnetic interference (EMI), however false readings can still occur due to the inherent variability and non-homogeneity of electrical and/or magnetic properties of pipes or tanks and substances conveyed within the piping systems introduced during manufacturing or in-service conditions. These characteristics, erroneously assumed to be constant and homogeneous in the prevailing devices and associated computational algorithms, serve as a root cause for such mismeasurements. For example, energized high voltage cables are housed within oil filled conduits or pipes. It should be appreciated that it is desirable to identify corrosion or other changes in the characteristics of the pipe so that remedial measures, if any, may be performed. In at least some instances, the magnetic fields caused by the energized cables interfere with the PEC testing, resulting in false data readings and/or increased inspection time and cost due to manual or other methods being used.

Accordingly, while existing systems and methods for performing PEC testing are suitable for their intended purpose, the need for improvement remains, particularly in the area of compensating for false readings that may occur during PEC testing.

### BRIEF DESCRIPTION

A method of pulsed eddy current (PEC) testing, in accordance with a non-limiting example, includes receiving metal loss output measurements. The metal loss output measurements are calculated based on eddy current response captured by a probe at a location on a pipe or tank, wherein one or more energized high voltage cables are located within the pipe or tank. The method further includes generating compensated metal loss output measurements to compensate for errors in the metal loss output measurements caused by the energized high voltage cables. The method further includes outputting the compensated metal loss output measurements as PEC test results.

A system for pulsed eddy current (PEC) testing, in accordance with a non-limiting example, is provided. The system includes a PEC tester configured to collect a plurality of metal loss output measurements at various locations of a pipe or tank made up of a ferrous material. One or more energized high voltage cables are located within the pipe or tank. The system further includes a processing system having a memory comprising computer readable instructions and a processing device for executing the computer readable instructions. The computer readable instructions control the processing device to perform operations. The operations include receiving the metal loss output measurements, generating compensated metal loss output measurements to compensate for errors in the metal loss output measurements caused by the energized high voltage cables, and outputting the compensated metal loss output measurements as PEC test results.

A machine learning system, in according with a non-limiting example is provided. The machine learning system includes a processing system having a memory comprising computer readable instructions and a processing device for executing the computer readable instructions. The computer readable instructions control the processing device to perform operations. The operations include receiving training data as input, the training data comprising pulsed eddy current (PEC) measurements from field tests. The operations further include simulated data from finite element modeling simulations, and pipe profiles from field testing, preprocessing the training data by performing feature extraction on the PEC measurements, data normalization, and scaling. The operations further include generating a trained machine learning model using results of the preprocessing of the training data, the trained machine learning model taking as input at least meat loss output measurements from a PEC tester and generated compensated metal loss output measurements.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a schematic illustration of a pipe and pulsed eddy current (PEC) test equipment according to one or more embodiments described herein;

FIG. 1B is a schematic illustration of a cross-section of the pipe having a cable disposed therein according to one or more embodiments described herein;

FIG. 2 is a schematic illustration of components of PEC test equipment according to one or more embodiments described herein;

FIG. 3A is first portion of an example of output from a feeder sweep measurement operation according to one or more embodiments described herein;

FIG. 3B is a second portion of the example of output from a feeder sweep measurement operation according to one or more embodiments described herein;

FIG. 4A is first portion of an example of output from a horizontal feeder measurement operation according to one or more embodiments described herein;

FIG. 4B is a second portion of the example of output from a horizontal feeder measurement operation according to one or more embodiments described herein;

FIG. 5A is a first portion of an example of output from a vertical oil return measurement operation according to one or more embodiments described herein;

FIG. 5B is a second portion of the example of output from a vertical oil return measurement operation according to one or more embodiments described herein;

FIG. 6 is a flow diagram of a method for performing PEC testing according to one or more embodiments described herein;

FIG. 7 is a block diagram of components of a machine learning training and inference system according to one of more embodiments described herein;

FIG. 8 is a schematic illustration of a computer system for implementing the presently described techniques according to one or more embodiments described herein;

FIG. 9 is a flow diagram of a method for performing compensation with machine learning according to one or more embodiments;

FIG. 10 is a flow diagram of a method for training the machine learning model of FIG. 7 according to one or more embodiments; and

FIG. 11 is a flow diagram of a method for perform completion including surrogate modeling and machine learning according to one or more embodiments.

The detailed description explains embodiments of the disclosure, together with advantages and features, by way of example with reference to the drawings.

### DETAILED DESCRIPTION

Embodiments described herein relate to pulsed eddy current (PEC) testing of pipes. One or more embodiments of the present disclosure compensate for, or correct, false results produced during PEC inspection of pipes that contain energized high voltage cables. The false readings can be caused, for example, by electromagnetic interference (EMI) emanating from the energized cables, material property variations (MPV) from the pipe fabrication process or due to the energized cables, and/or the presence of the metallic mass (MM) of the high voltage cables. While some contemporary PEC equipment may contain electronic filtration of EMI, false readings can still occur due, for example, to variation in the distance from a PEC probe to the energized cables. Embodiments described herein are designed to identify and compensate for errors caused by conditions such as EMI, MPV, and MM in PEC testing of pipes and tanks, thus improving the accuracy of inspection results for pipes containing energized high voltage cables.

As used herein, the terms “false results” and “false readings” are used interchangeably to refer to incorrect PEC test results, such as, but not limited to, an incorrect pipe thickness measurement.

As used herein, the term “EMI filter” refers to an electronic circuit device that is used to suppress EMI, such as noise in power lines or control signal lines. An EMI filter can be used to decrease electronic noise that may occur due to interference with other devices. Signal filtering is often used in eddy current testing to eliminate unwanted frequencies from the receiver signal. While the correct filter settings can significantly improve the visibility of a defect signal, incorrect settings can distort the signal presentation and even eliminate the defect signal completely.

One or more embodiments of the present disclosure can be added to or used with existing PEC test equipment to compensate for the false readings in a real-time manner during the inspection process. In one or more other embodiments, the correction to any false readings is performed after at least a portion of the inspection is complete by, for example, a stand-alone processor that receives the data from the PEC test equipment as part of post-inspection processing. The compensation calculation(s) can be performed by hardware, software, and/or firmware.

One or more embodiments described herein can be used for inspection of above ground and below ground high voltage feeder pipes. In addition, or alternatively, one or more embodiments described herein can be used for inspection of above ground and below ground pipes used to transmit (or to distribute) pressurized or unpressurized water, steam, fuel gases, and/or liquid fuels. In addition, or alternatively, one or more embodiments described herein can be used for inspection of tanks containing pressurized or unpressurized water, steam, fuel gases, and/or liquid fuels.

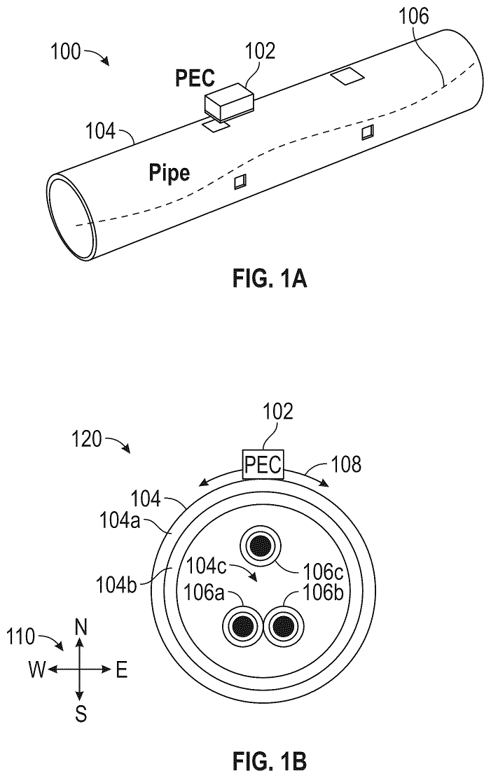

Turning now to FIG. 1A, a schematic illustration 100 of a pipe 104 and PEC test equipment 102 is generally shown in accordance with one or more embodiments described herein. As shown in FIG. 1A, the PEC test equipment 102 is used for detecting flaws or corrosion in the pipe 104 by moving along the surface of the pipe 104 and taking measurements of the thickness of the pipe 104 in a process referred to as PEC testing.

The pipe 104 shown in FIG. 1A contains at least one high voltage cable 106. Examples of high voltage cables that may be inside the pipe 104, include, but are not limited to, electric transmission cables. In some embodiments, there are three cables in each pipe (e.g., the pipe 104), one cable associated with each phase of three-phase power. However, in other embodiments, other numbers of cables can be used. In some cases, a single cable with multiple electrical paths can be used. A cable can be considered to have a high voltage when its voltage is between about 50 KV and about 1,000 KV. As described previously, the presence of one or more a high voltage cables (e.g., the high voltage cable 106) in the pipe 104 can cause false results during PEC testing due to electromagnetic interference (EMI) emanating from the cable(s). For example, it should be appreciated that the relative positioning of the cable(s) within the pipe 104 may change along the length of the pipe causing the EMI levels to vary and hinder the ability for prior art devices to filter issues caused by EMI.

FIG. 1B is a schematic illustration 120 of a cross-section of the pipe 104 having the cable 106 disposed therein according to one or more embodiments described herein. The pipe includes an insulation layer 104a and a pipe wall 104b. Cables 106a, 106b, 106c are disposed in an interior passage 104c of the pipe 104. Although three cables 106a, 106b, 106c are shown, other numbers of cables are possible in other embodiments. The PEC test equipment 102 is positioned on a portion of the pipe 104 as shown. To perform PEC testing, the PEC test equipment 102 can inspect the pipe 104 at various points around the circumference of the pipe 104. That is, the PEC 102 can move in a clockwise direction and/or a counterclockwise direction about the circumference of the pipe 104 along the direction shown by the arrow 108. In the present description, the position of the PEC test equipment 102 relative to the pipe 104 is described using cardinal (e.g., N, S, E, W) and ordinal directions (e.g., NNE, NE, ENE, ESE, SE, SSE, SSW, SW, WSW, WNW, NW, NNW). Such positioning is relative to the pipe 104, not the Earth. For example, in FIG. 1B, the PEC test equipment 102 is position at a “north” or “N”) position as shown by the compass 110.

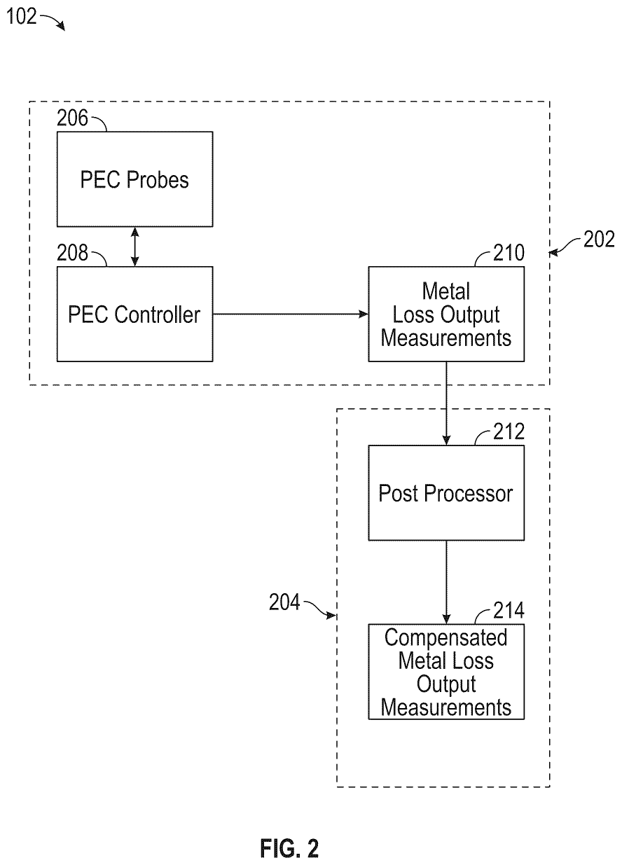

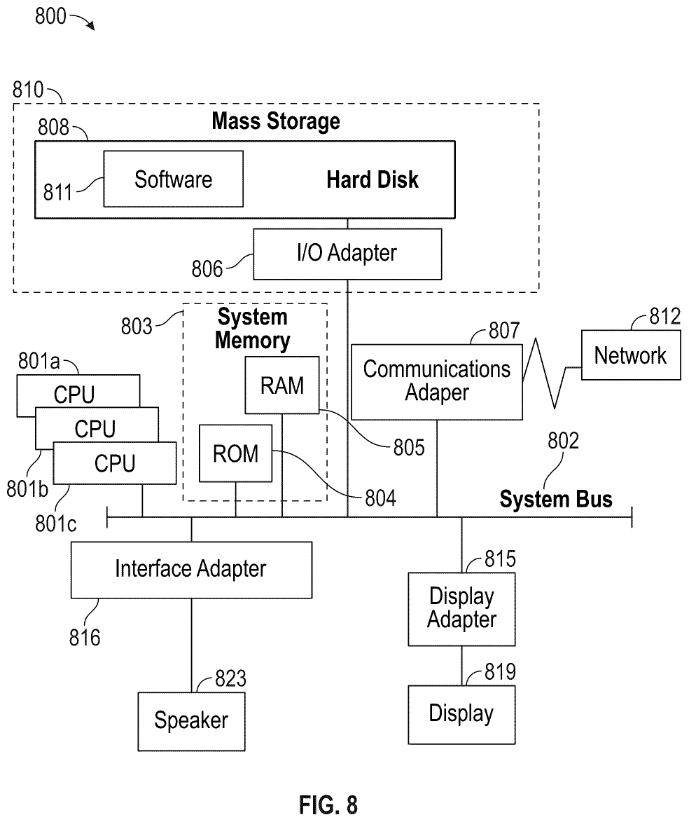

Turning now to FIG. 2, a schematic illustration of components of PEC test equipment 102 is generally shown in accordance with one or more embodiments of the present disclosure. according to one or more embodiments, all or a portion of the PEC test equipment 102 can be implemented using one or more of the elements of computer system 800 of FIG. 8 or another suitable system or device. The components of the PEC test equipment 102 shown in FIG. 2 include PEC test measurement component 202 and PEC test compensation component 204. The PEC test measurement component 202 shown in FIG. 2 includes one or more PEC probes 206, a PEC controller 208, and metal loss output measurements 210. As shown in FIG. 2, the PEC probes 206 are controlled by the PEC controller 208. The PEC probes 206 are activated by the PEC controller 208 to generate eddy currents and the PEC controller 208 obtains data from the PEC probes 206 that have been activated to obtain the metal loss output measurements 210. In one or more embodiments, the PEC test measurement component 202 is implemented by a commercially available PEC tester such as, but not limited to, Eddyfi's Lyft tester and testers produced by Applus+.

In one or more embodiments, all or a portion the PEC test measurement component 202 is implemented by an automated system, such as a robotic device, that is controlled (e.g., remotely) to move along the surface of the pipe 104. In these one or more embodiments, the PEC probes 206 can be included in a housing that is remotely controlled by the PEC controller 208. The PEC controller 208 controls the movement of the PEC probes 206 and reads the eddy currents captured by the PEC probes 206 to calculate pipe thickness, or metal loss output measurements 210. Examples of robotic devices that can be used by one or more embodiments include, but are not limited to, robots produced by ARIX Technologies and Applus+.

The robotic device navigates along the pipeline, performing inspections by projecting electromagnetic pulses to induce eddy currents within the material. This setup provides for comprehensive data collection in challenging and confined spaces, capturing detailed PEC signals for subsequent analysis. The robotic device (represented by the PEC test measurement component 202) can be mounted on the pipe 104, as shown in FIGS. 1A and 1B, with sensor(s) (e.g., PEC probes 206) actively projecting electromagnetic pulses onto a pipe surface of the pipe 104. These pulses induce transient eddy currents within the material, which are used for capturing the PEC response signals. According to one or more embodiments, the robotic device is equipped with sensors (e.g., PEC probes 206) and navigational capabilities, enabling the robot to operate efficiently in various inspection scenarios. For example, the robotic device can perform a non-contact inspection of a pipeline (e.g., the pipe 104). The robotic device projects electromagnetic pulses onto the pipe surface, inducing transient eddy currents within the material. These currents are used for capturing the PEC response signals for further analysis. The deployment aimed to capture detailed and accurate signals from various parts of the pipeline system, ensuring that data reflected real-world operational scenarios.

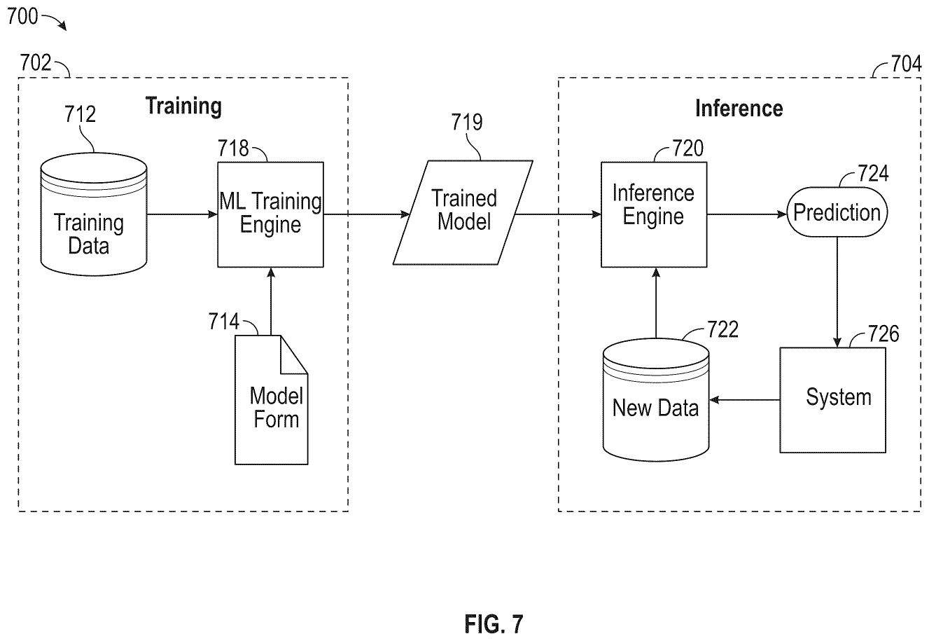

The PEC test compensation component 204 of the PEC test equipment 102 shown in FIG. 2 includes a post processor 212 and compensated metal loss output measurements 214. In accordance with one or more embodiments, the post processor 212 receives the metal loss output measurements 210 from the PEC test measurement component 202 and modifies the metal loss output measurements 210, if desired, to compensate for errors caused by energized high voltage cables (e.g., the high voltage cable 106) in the pipe 104 or a tank. According to one or more embodiments, the post processor 212 can implement machine learning techniques as described herein (see, e.g., FIG. 7) to generate the compensated metal loss output measurements 214. The compensated metal loss output measurements 214 are output from the PEC test compensation component 204 for storage and/or display to a user. In one or more embodiments, the compensated metal loss output measurements 214, or pipe thickness measurements, are stored in a storage device such as mass storage 810 and/or system memory 803 of FIG. 8. The compensated metal loss output measurements 214, or pipe thickness estimates, can also be output to a display such as display 819 of FIG. 8.

In one or more embodiments, the components of the PEC test equipment 102 shown in FIG. 2 may be arranged with fewer or more components than shown in FIG. 2. For example, the PEC test compensation component 204 may be combined with the PEC test measurement component 202, with the post processor 212 functions being performed by the PEC controller 208. In other embodiments, all of the components of the PEC test equipment 102 are located on a single physical device. In other embodiments, the PEC test measurement system 202 and the PEC test compensation component 204 are located on separate physical devices that communication via a network, such as network 812 of FIG. 8. In other embodiments, the PEC controller 208 is spread across two or more physical devices, with functions that generate the magnetic field via the PEC probes 206 located in one physical device and the other functions of the PEC controller 208 located on one or more other physical device(s).

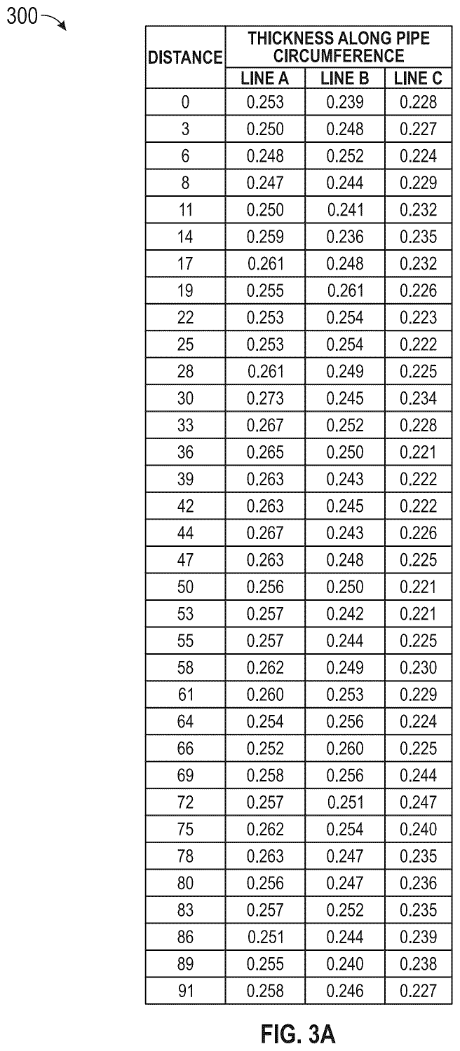

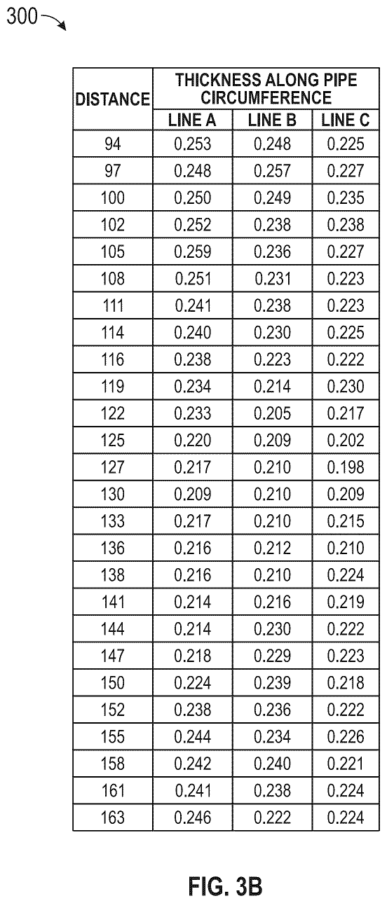

Turning now to FIGS. 3A and 3B, an example of output 300 from a feeder sweep measurement operation is generally shown in accordance with one or more embodiments. The output 300 shown in FIG. 3 may be displayed to a user via a display, such as display 819 of FIG. 8. As used herein, the term “feeder sweep measurement operation” or “sweeps” should be understood to describe a gradual transition from vertical pipe runs to horizontal pipe runs or vice-versa. Sweep length is typically tied to pipe diameter. The output 300 shown in FIG. 3 is generated by PEC test equipment, such as the PEC test equipment 102 of FIG. 2.

The output 300 shown in FIGS. 3A and 3B shows a first column of measurements, labeled “Distance” and a second column of measurements labeled “Thickness along pipe circumference.” The second column has three sub-columns labeled “Line A,” “Line B,” and “Line C,” which each represent wall thicknesses of the pipe at three measurement locations about the circumference of the pipe 104. For example, the PEC test equipment 102 can take measurements about the circumference at three substantially equally spaced locations (e.g., every 120 degrees about the circumference of the pipe 104). The numbers (distance) in the first column “0”, “3”, “6”, etc. represent the location of the PEC test equipment 102 from a starting point (origin) as measured in inches, and the numbers in the three sub-columns for Line A, Line B, and Line C “0.253”, “0.239”, “0.228”, etc. represent the thickness of the pipe wall of the pipe 102 at the measurement points about the circumference of the pipe 102.

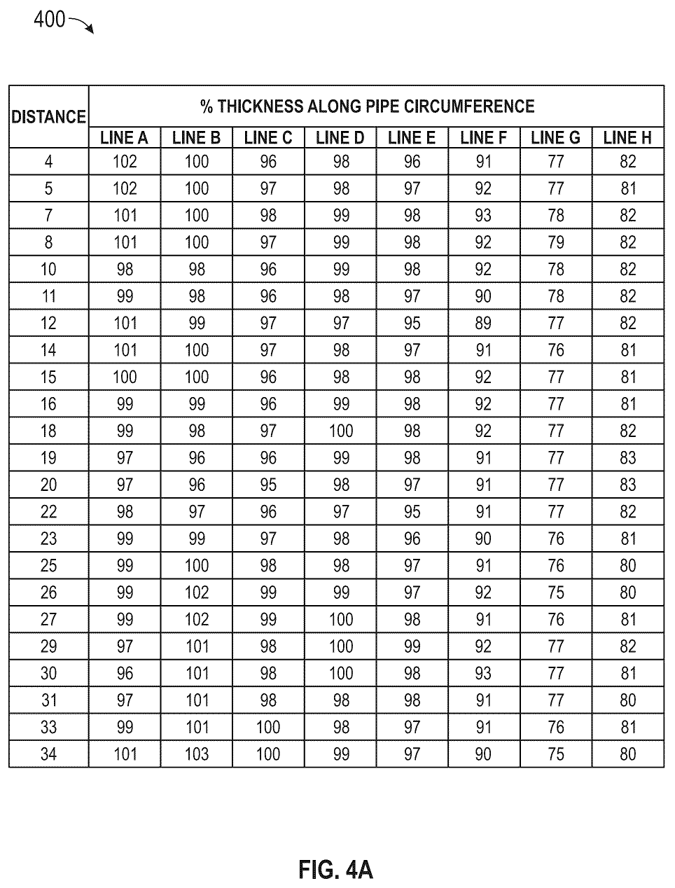

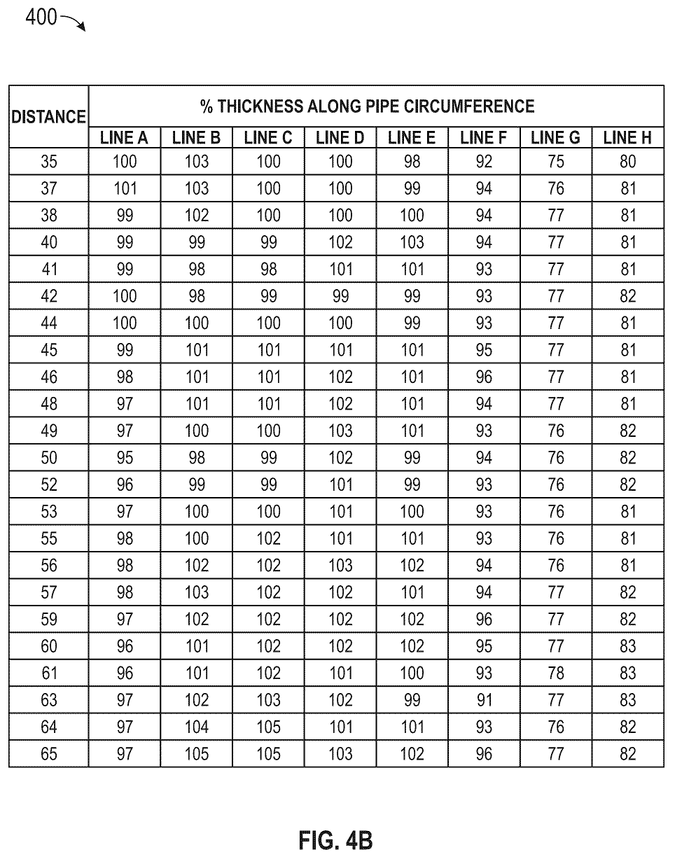

Turning now to FIGS. 4A and 4B, an example of output 400 from a horizontal feeder measurement operation is generally shown in accordance with one or more embodiments. The output 400 shown in FIGS. 4A and 4B may be displayed to a user via a display, such as display 819 of FIG. 8. As used herein, the term “horizontal feeder measurement operation” refers to a measurement operation in which a robotic device (e.g., the PEC test equipment 102) may move along a length of the pipe 104 taking measurements while the pipe is oriented substantially horizontally relative to the Earth's surface. The robotic device may create a map of the PEC measurements to a specific location on the pipe 104. The output 400 shown in FIGS. 4A and 4B is generated by PEC test equipment, such as PEC test equipment 102 of FIG. 2.

The output 400 shown in FIGS. 4A and 4B shows a first column of measurements, labeled “Distance” and a second column of measurements labeled “% Thickness along pipe circumference.” The second column has eight sub-columns labeled “Line A,” “Line B,” “Line C,” “Line D,” “Line E,” “Line F,” “Line G,” and “Line H,” which each represent wall thicknesses of the pipe at eight measurement locations about the circumference of the pipe 104. For example, Line A measurements can be captured at a “North” location relative to the pipe 104 (see, e.g., FIG. 1B), Line B measurements can be captured at a “North East” location relative to the pipe 104, and each of Lines C-H can be similarly captured at locations “East,” “South East,” “South,” “South West,” “West,” and “North West” respectively.

The measurements are expressed as a percentage of the residual wall thickness, compared against either the nominal thickness of an untarnished pipe wall, or the calibrated thickness of the inspected pipe wall under scrutiny. Here, the latter two scenarios are taken as a benchmark, signifying a full or 100 percent thickness. The measurement value “97” indicates that the residual wall thickness is 97 percent of the full percent thickness on a side of the pipe opposite a walkway, and the measurement value “94” indicates that the residual wall thickness is 94 percent of the full percent thickness on the opposite side of the pipe which is facing the walkway.

In accordance with one or more embodiments, the measurement values in the output 400 are color coded to indicate particular ranges of measurement values. For example, the measurement values can be shown on a color continuum with values around 40 being displayed in red, values around 55 being displayed in orange, values around 64 displayed in yellow, values around 77 displayed in green, values around 87 displayed in light blue, values around 96 displayed in medium blue, and values around 107 displayed in dark blue. This can make it easier for a user to quickly view the output and identify areas of the pipe 104 that may have a flaw due for example, to corrosion. It should be appreciated that the values and corresponding colors are non-limiting, and other values and/or colors (including various combinations thereof) can be used in other examples.

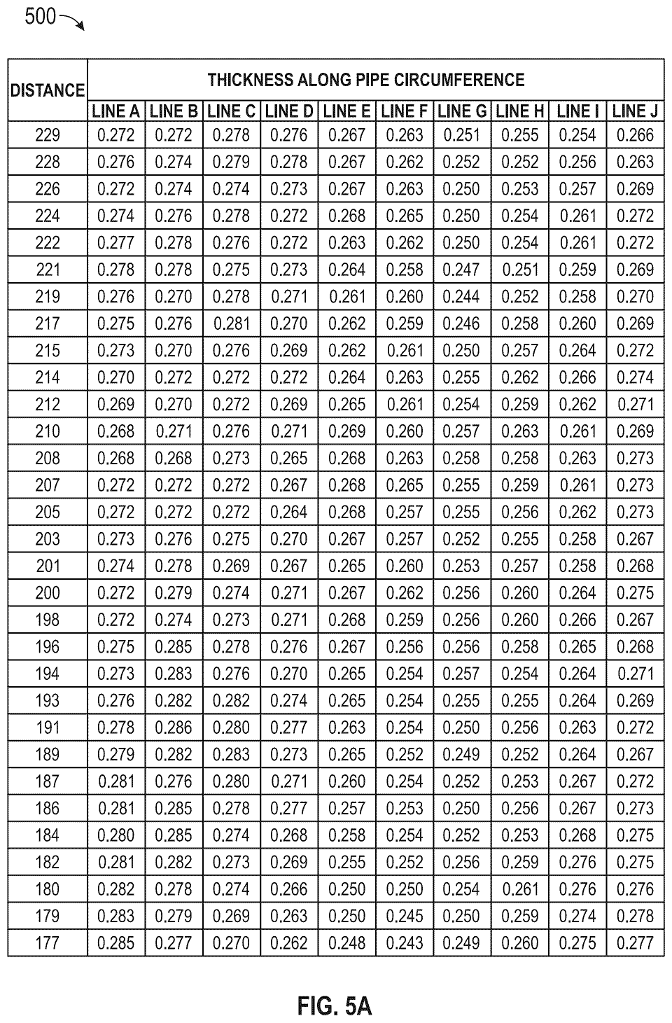

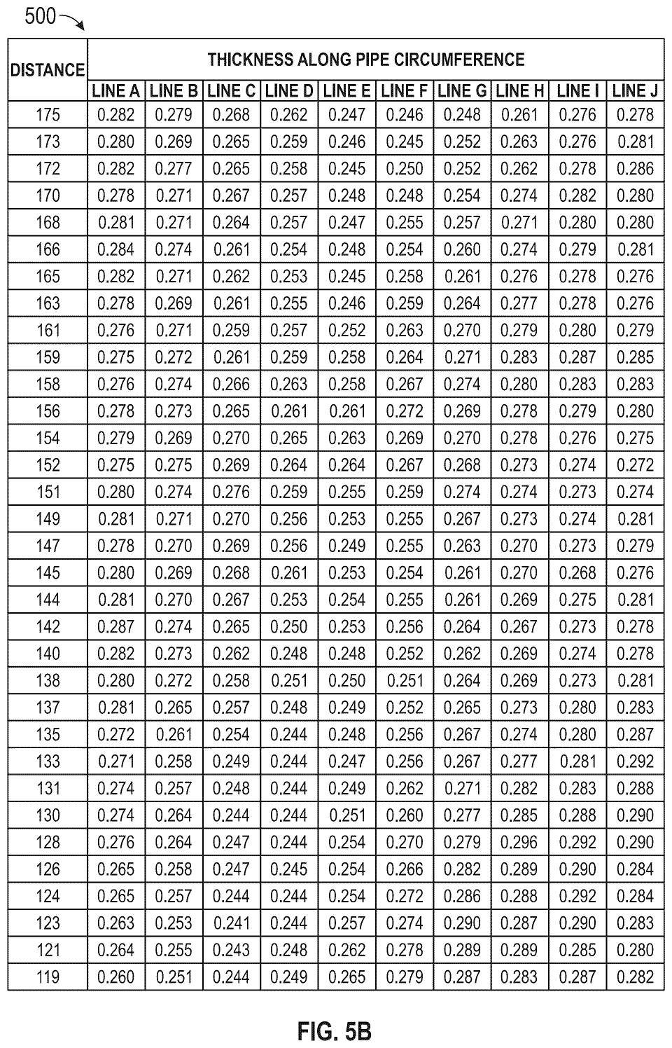

Turning now to FIGS. 5A and 5B, an example of output 500 from a vertical return measurement operation is generally shown in accordance with one or more embodiments. As used herein, the term “vertical return measurement operation” refers to measurements taken about a circumference the pipe as the robotic crawler moves along the outer surface of the pipe 104 while the pipe is oriented substantially vertically relative to the Earth's surface. The output 500 shown in FIGS. 5A and 5B is generated by PEC test equipment, such as PEC test equipment 102 of FIG. 2.

The output 500 shown in FIGS. 5A and 5B shows a first column of measurements, labeled “Distance” and a second column of measurements labeled “Thickness along pipe circumference.” The second column has ten sub-columns labeled “Line A,” “Line B,” “Line C,” “Line D,” “Line E,” “Line F,” “Line G,” “Line H,” “Line I”, and “Line J,” which each represent wall thicknesses of the pipe at eight measurement locations about the circumference of the pipe 104. For example, the output 500 shows a first sub-column of measurements (“Line A”) for a pipe orientation of east south east (“ESE”), a second sub-column of measurements (“Line B”) for a pipe orientation of “south south east (“SSE″), a third sub-column of measurements (“Line C”) for a pipe orientation of south south west (“SSW”), a fourth sub-column of measurements (“Line D”) for a pipe orientation of west south west (“WSW”), a fifth sub-column of measurements (“Line E”) for a pipe orientation of west (“WEST”), a sixth sub-column of measurements (“Line F”) for a pipe orientation of west north west (“WNW”), a seventh sub-column of measurements (“Line G”) for a pipe orientation of north north west (“NNW”), an eighth sub-column of measurements (“Line H”) for a pipe orientation of north north east (“NNE”), a ninth sub-column of measurements (“Line”) for a pipe orientation of east north east (“ENE″), and a tenth sub-column of measurements (“Line J”) for a pipe orientation of east (“EAST”).

The measurements in FIGS. 5A and 5B are expressed as the actual pipe residual wall thickness in the unit of inches, and the measurement values in the output 500 can be color coded to indicate particular ranges of measurement values. The output 500 shown in FIGS. 5A and 5B is generated by PEC test equipment, such as PEC test equipment 102 of FIG. 2.

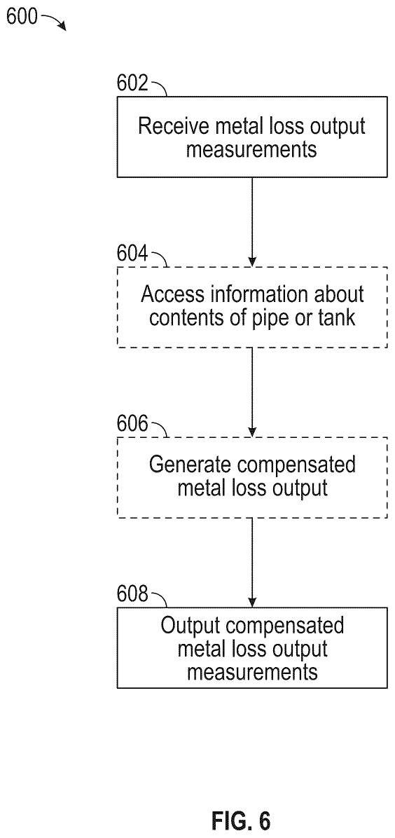

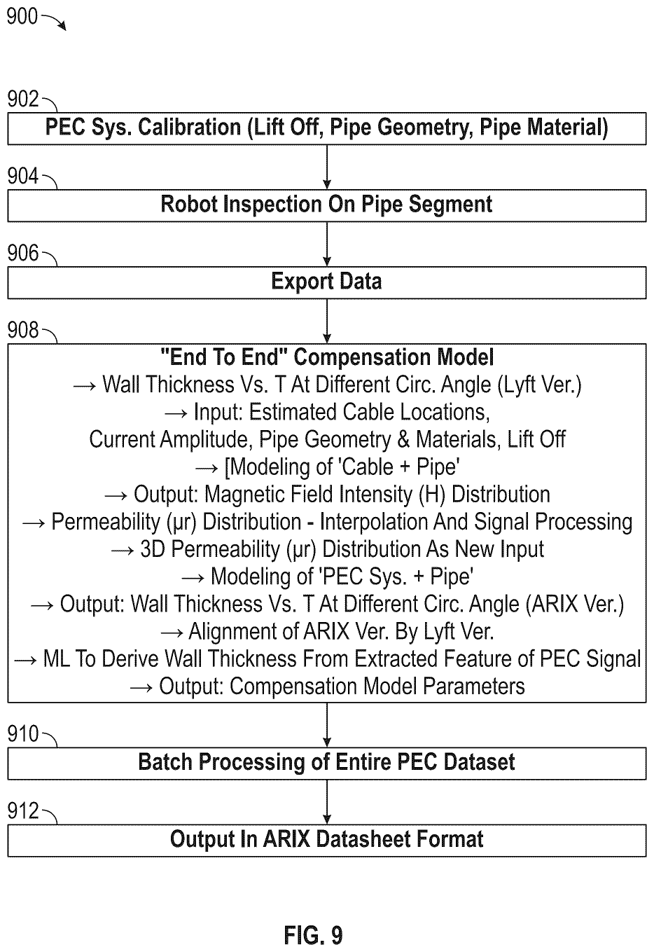

Turning now to FIG. 6, a flow diagram 600 of a method for performing PEC testing is generally shown in accordance with one or more embodiments. The processing shown in FIG. 6 can be performed by the post processor 212 of FIG. 2 or another suitable system/device. At block 602, metal loss output measurements, such as metal loss output measurements 210 of FIG. 2 are received from a pipe or tank having high voltage cables (e.g., the pipe 102 having the cable 106 disposed therein). At block 604 of FIG. 6, information about the pipe including contents of the pipe and the like is received from a user or accessed from a storage location, such as system memory 803 of FIG. 8. At block 606, a compensated metal loss output is generated. The compensated metal loss output compensates for false readings that may stem from changes in properties of the metal due to changing magnetic properties. At block 608, compensated metal loss output measurements 214 are output. Further details of the method 600 are described herein with reference to FIGS. 9-11.

It should be understood that the process depicted in FIG. 6 represents an illustration, and that other processes may be added or existing processes may be removed, modified, or rearranged without departing from the scope of the present disclosure.

Turning now to FIG. 7, a block diagram 700 of components of a machine learning training and inference system is generally shown in accordance with one or more embodiments.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for classifying a feature of interest, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of predicting pipe wall thickness using pulsed eddy current measuring techniques as described herein.

Systems for training and using a machine learning model are now described in more detail with reference to FIG. 7. Particularly, FIG. 7 depicts a block diagram of components of a machine learning training and inference system 700 according to one or more embodiments described herein. The system 700 performs training 702 and inference 704. During training 702, the ML training engine 718 trains a model (e.g., the trained model 719) to perform a task, training the algorithm to recognize flaws such as corrosion damage. Inference 704 is the process of implementing the trained model 719 to perform the task, such as to classify corrosion damage, in the context of a larger system (e.g., a system 726). All or a portion of the system 700 shown in FIG. 7 can be implemented, for example by all or a subset of the computer system 800 OF FIG. 8.

The training 702 begins with training data 712, which may be structured or unstructured data. The ML training engine 718 receives the training data 712 and a model form 714. The model form 714 represents a base model that is untrained. The model form 714 can have preset weights and biases, which can be adjusted during training. It should be appreciated that the model form 714 can be selected from many different model forms depending on the task to be performed. For example, where the training 702 is to train a model to perform image classification, the model form 714 may be a model form of a CNN. The training 702 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 712 includes labeled images, including images of the object of interest with associated labels (ground truth) and other images that do not include the object of interest with associated labels. In this example, the ML training engine 718 takes as input a training image from the training data 712, makes a prediction for classifying the image, and compares the prediction to the known label. The ML training engine 718 then adjusts weights and/or biases of the model based on results of the comparison, such as by using backpropagation. The training 702 may be performed multiple times (referred to as “epochs”) until a suitable model is trained (e.g., the trained model 719).

Once trained, the trained model 719 can be used to perform inference 704 to perform a task, such as to classify corrosion damage. The inference engine 720 applies the trained model 719 to new data 722 (e.g., real-world, non-training data). For example, if the trained model 719 is trained to classify images of a particular object, such as a chair, the new data 722 can be an image of a chair that was not part of the training data 712. In this way, the new data 722 represents data to which the model trained has not been exposed. The inference engine 720 makes a prediction 724 (e.g., a classification of an object in an image of the new data 722) and passes the prediction 724 to the system 726. The system 726 can, based on the prediction 724, taken an action, perform an operation, perform an analysis, and/or the like, including combinations and/or multiples thereof. In some embodiments, the system 726 can add to and/or modify the new data 722 based on the prediction 724.

In accordance with one or more embodiments, the predictions 724 generated by the inference engine 720 are periodically monitored and verified to ensure that the inference engine 720 is operating as expected. Based on the verification, additional training 702 may occur using the trained model 719 as the starting point. The additional training 702 may include all or a subset of the original training data 712 and/or new training data 712. In accordance with one or more embodiments, the training 702 includes updating the trained model 719 to account for changes in expected input data.

Training machine learning models (e.g., the trained model 719) uses training data (e.g., the training data 712). In some cases, sufficient training data may not be available. Without sufficient training data, models cannot be trained to a desired level of accuracy, for example. For example, according to one or more embodiments described herein, a model trained with insufficient training data may not be able to correctly classify corrosion damage.

In an effort to cure this deficiency (e.g., lack of sufficient training data), one or more embodiments described herein provides for using synthetic training data for training a machine learning model that can be used for classifying corrosion damage. Synthetic data acts as a substitute for or supplement to real-world training data (referred to as “original” training data) and provides similar properties as the real-world training data. Thus, the synthetic data increases the amount of data available for training machine learning models. There are two primary types of synthetic training data: fully synthetic training data (e.g., no real-world data available) and partially synthetic training data (e.g., some real-world data available, and the synthetic data is aimed to be similar to this real-world data). According to one or more embodiments, synthetic data can be used to solve the inverse problem of wall thickness estimation from PEC response signals. For synthetic data generation for training a machine learning model, numerical models can be used to generate a large amount of synthetic data for machine learning model training and development. In an embodiment, the characteristic delay time (a feature extracted from the PEC response signal) can be used to generate synthetic data. In another embodiment, a radial basis function neural network (RBFNN) can be used to generate synthetic data. In this case, pipes with known, precisely machine defects serve as controlled samples and are used to calibrate and validate PEC techniques for deriving wall thickness. By comparing the PEC response signals to these known defect profiles, algorithms can be developed and refined to accurately determine wall thickness in real-world scenarios.

It is understood that one or more embodiments described herein is capable of being implemented in conjunction with any other type of computing environment now known or later developed. For example, turning now to FIG. 8, a computer system 800, or processing system, is generally shown in accordance with an aspect. The computer system 800 can be an electronic computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 700 may be, for example, a server, desktop computer, laptop computer, tablet computer, or smartphone. In some examples, computer system 800 may be a cloud computing node. Computer system 800 may be described in the general context of computer-executable instructions, such as program modules, being executed by a computer system. Generally, program modules may include routines, programs, objects, components, logic, data structures, and so on that perform particular tasks or implement particular abstract data types. Computer system 800 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 8, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801, also referred to as processing circuits, are coupled via a system bus 802 to a system memory 803 and various other components. The system memory 803 can include one or more memory devices, such as read-only memory (ROM) 804 and a random-access memory (RAM) 805. The ROM 804 is coupled to the system bus 802 and may include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include random access memory (RAM), read-only memory, flash memory, or any other suitable memory systems.

The computer system 800 comprises an input/output (I/O) adapter 806 and a communications adapter 807 coupled to the system bus 802. The I/O adapter 806 may be a small computer system interface (SCSI) adapter that communicates with a hard disk 808 and/or any other similar component. The I/O adapter 806 and the hard disk 808 are collectively referred to herein as a mass storage 810.

Software 811 for execution on the computer system 800 may be stored in the mass storage 810. The mass storage 810 is an example of a tangible storage medium readable by the processors 801, where the software 811 is stored as instructions for execution by the processors 801 to cause the computer system 800 to operate, such as is described hereinbelow with respect to the various Figures. Examples of computer program product and the execution of such instruction is discussed herein in more detail. The communications adapter 807 interconnects the system bus 802 with a network 812, which may be an outside network, enabling the computer system 800 to communicate with other such systems. In one aspect, a portion of the system memory 803 and the mass storage 810 collectively store an operating system, which may be any appropriate operating system to coordinate the functions of the various components shown in FIG. 8.

Additional input/output devices are shown as connected to the system bus 802 via a display adapter 815 and an interface adapter 816 and. In one aspect, the adapters 806, 807, 815, and 816 may be connected to one or more I/O buses that are connected to the system bus 802 via an intermediate bus bridge (not shown). A display 819 (e.g., a screen or a display monitor) is connected to the system bus 802 by a display adapter 815, which may include a graphics controller to improve the performance of graphics-intensive applications and a video controller. A keyboard, a mouse, a touchscreen, one or more buttons, a speaker, etc., can be interconnected to the system bus 802 via the interface adapter 816, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 800 includes processing capability in the form of the processors 801, and storage capability including the system memory 803 and the mass storage 810, input means such as the buttons, touchscreen, and output capability including the speaker 823 and the display 819.

In some aspects, the communications adapter 807 can transmit data using any suitable interface or protocol, such as the internet small computer system interface, among others. The network 812 may be a cellular network, a radio network, a wide area network (WAN), a local area network (LAN), or the Internet, among others. An external computing device may connect to the computer system 800 through the network 812. In some examples, an external computing device may be an external web server or a cloud computing node.

It is to be understood that the block diagram of FIG. 8 is not intended to indicate that the computer system 800 is to include all of the components shown in FIG. 8. Rather, the computer system 800 can include any appropriate fewer or additional components not illustrated in FIG. 8 (e.g., additional memory components, embedded controllers, modules, additional network interfaces, etc.). Further, the aspects described herein with respect to computer system 800 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects.

FIG. 9 is a flow diagram of a method 900 for performing compensation with machine learning according to one or more embodiments. The method 900 can be performed by or using any of the systems, devices, and/or components described herein.

At block 902, PEC system (e.g., the PEC test measurement component 202 of FIG. 2) calibration is performed. Calibration aids in ensuring that the PEC test measurement component 202 provides accurate wall thickness measurements. Calibration involves selecting the right calibration spot on the circumference of the pipe 104 to avoid interference from features like welds or insulation supports. In lab-scale tests, precise techniques such as Ultrasonic Testing (UT) can be employed to determine and verify regions of “100% wall thickness percentage.” This provided a controlled and highly accurate reference point, useful for establishing a reliable baseline. UT is known for its accuracy in measuring wall thickness, making it a suitable method for this purpose. By using UT, the baseline regions can be precisely defined, reducing the potential for error in subsequent PEC measurements.

The calibration process includes several steps, such as finding a suitable location, performing an initial SmartPulse, and adjusting based on the results. According to one or more embodiments, recalibration is performed over an area rather than a single point to average out noise. The calibration steps involved finding a suitable location, performing initial and subsequent SmartPulses, and finalizing the calibration at the optimal reference point. Wall Thickness (WT) calibration used the average of multiple pulses to define a reference thickness, which could be adjusted based on known measurements. The Tau-scan is a tool used to assess the quality of the calibration. An acceptable calibration gives a Tau-scan with a smooth slope at the beginning with a plateau stopping between 3 and 4 CDT at the end. By combining these approaches, a robust relationship between the PEC signal decay time and WT is established, serving as the foundation for subsequent calibration and analysis. This ensured that the baseline calibration was both accurate and practical, providing a reliable basis for effective PEC data interpretation.

At block 904, the robot device (e.g., the PEC test measurement component 202 of FIG. 2) perform inspection of the pipe segment (e.g., the pipe 104 of FIGS. 1A and 1B) as described herein. The inspection generates the metal loss output measurements 210. At block 906, the data (e.g., the are exported metal loss output measurements 210 for analysis, such as to the PEC test compensation component 204 or the inference engine 720. At block 908, an end-to-end compensation model (e.g., the trained model 719) is implemented by the inference engine 720 to perform inference 704 to evaluate wall thickness of the pipe 104.

The numerical modeling of the cable 106 plus pipe 104 represents the complex interplay between the pipe's material characteristics and the magnetic field generated by the current-carrying cables. The simulation details the spatial arrangement of the pipe 104 and cable 106, emphasizing key parameters such as the outer diameter (OD) of the pipe, the thickness of the pipe wall, the insulation layer, and the position of the cables within the pipe. Consider the following non-limiting example. The pipe 104 has an OD of substantially 291.1 mm, with a pipe wall thickness of substantially 6.35 mm and an insulation layer of substantially 6.35 mm. The cables 106a, 106b, 106c are grouped centrally within the pipe 104, each having a lead diameter of substantially 15.2 mm. The cables 106a, 106b, 106c are shifted substantially 50.8 mm from the center of the pipe 104. This simulation is useful for capturing the effects of both the material properties of the pipe 104 and the magnetic interference caused by the nearby cables 106a, 106b, 106c. The model helps in understanding how the proximity and positioning of the cables 106a, 106b, 106c affect the magnetic field distribution around the pipe 104 and, consequently, the PEC signal decay pattern. This detailed simulation is useful for approximating the location and influence of the cables 106a, 106b, 106c, even when their exact positions are unknown.

A hysteresis loop is a fundamental characteristic of ferromagnetic materials, such as carbon steel, depicting the relationship between the magnetic field strength (H) and the magnetic flux density (B). When a ferromagnetic material is subjected to a varying magnetic field, the B-H curve (or hysteresis loop) is generated, showing how the material's magnetization responds to the external magnetic field. The loop's shape illustrates certain magnetic properties, such as coercivity, retentivity, and saturation magnetization. As the magnetic field (H) increases, the magnetic flux density (B) also increases, following the initial magnetization curve until the material reaches saturation. Upon reducing the magnetic field, the flux density does not follow the initial curve but instead traces a different path, illustrating the material's retentivity (the residual magnetization when H is zero). To demagnetize the material, a negative magnetic field must be applied, leading to coercivity, the point at which B becomes zero. The loop completes as the field varies in the opposite direction and then returns to its original state. From the B-H curve, the μ-H (permeability vs. magnetic field strength) curve can be derived, which provides insights into the material's magnetic permeability (u). Permeability (u) is defined as the ratio of the magnetic flux density (B) to the magnetic field strength (H). Permeability (u) indicates how easily a material can be magnetized. For carbon steel, a typical ferromagnetic material, permeability varies significantly with the applied magnetic field. A μ-H curve for carbon steel, derived from the B-H curve is now described. Initially, the permeability is high, indicating that the material is easily magnetized. However, as the magnetic field strength increases, permeability decreases, reflecting the material's approach to saturation. At higher field strengths, the relative permeability drops significantly, indicating that the material's capacity to support additional magnetic flux diminishes. This μ-H relationship is useful for understanding and modeling the PEC response, as it directly influences the eddy currents induced in the material and, consequently, the signal decay patterns observed. Accurately capturing this variation is useful for refining numerical simulations and improving the reliability of PEC measurements in ferromagnetic materials like carbon steel.

In the context of numerical modeling, the inputs include the geometric and material properties of the pipe 104 and cables 106a, 106b, 106c, such as the OD of the pipe 104, the thickness of the pipe wall, the insulation layer, and the position of the cables. Additionally, the magnetic field strength (H) and the corresponding permeability values (u) derived from the B-H curve of the material are also inputs. The simulations consider the relative positioning of the cables 106a, 106b, 106c and their current-carrying capacities, which influence the magnetic field distribution around the pipe.

The outputs of these simulations are the distributions of the magnetic field intensity (H) and the relative permeability around the pipe, as well as along its circumferential location. These outputs provide a detailed map of how the magnetic field and permeability vary in response to the presence of the cables. By analyzing these distributions, the complex interactions between the magnetic fields generated by the cables and the material properties of the pipe can be understood. This understanding is useful for accurately modeling the PEC response and ensuring the reliability of PEC measurements, ultimately leading to more precise assessments of the pipe's condition and integrity.

At block 910, batch processing is performed. In the context of pulsed eddy current data analysis, batch processing refers to grouping multiple data sets together and automatically processing them, which results in performing PEC data compensation more efficiently. According to one or more embodiments, batch processing can be used for automatically processing multiple sets of PEC data (from different PEC scans) for different pipe sections. According to one or more embodiments, batch processing can be used to generate visualizations for multiple datasets without manual intervention.

At block 912, results of the batch processing from block 910 are output. According to one or more embodiments, the output can be in a datasheet format, although other formats are also possible, such as plain text, comma separated values, and/or the like, including combinations and/or multiples thereof.

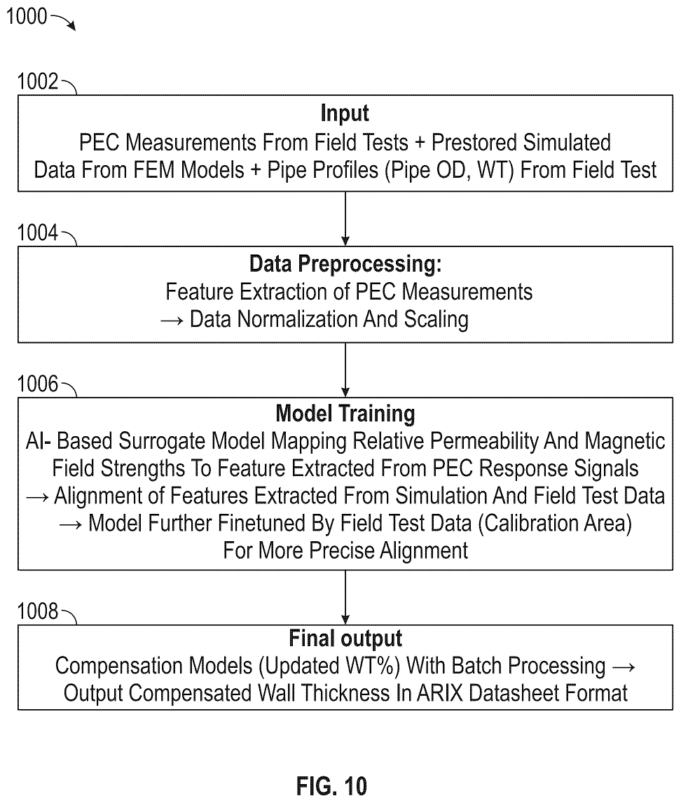

FIG. 10 is a flow diagram of a method 1000 for training the machine learning model 719 according to one or more embodiments. The method 1000 can be performed by or using any of the systems, devices, and/or components described herein. For example, the method 1000 can be performed by the ML training engine 718 to perform training 702.

At block 1002, input are received. The input includes PEC measurements from field tests, presorted simulated data from Finite Element Modeling (FEM) simulations, and pipe profiles (e.g., pipe outside diameter, WT) from field testing. These data represent examples of the training data 712.

At block 1004, data preprocessing is performed. The data preprocessing can include feature extraction of PEC measurements, data normalization and scaling, and/or the like, including combinations and/or multiples thereof.

At block 1006, training 702 is preformed to generate the trained model 719. For example, training 702 can include mapping an AI-based surrogate model relative permeability and magnetic field strengths to features extracted from PEC response signals. As another example, training 702 can include aligning features extracted from simulation and field test data. As another example, training 702 includes fine tuning the trained model 719 using further field test data for more precise alignment.

At block 1008, the trained model 719 is generated and output by the training engine 718. The trained model 719 is a compensation model (updated wall thickness percentages) with batch processing. The model outputs a compensated wall thickness, such as in a datasheet format or another suitable format (e.g., plain text, comma separated values, and/or the like, including combinations and/or multiples thereof).

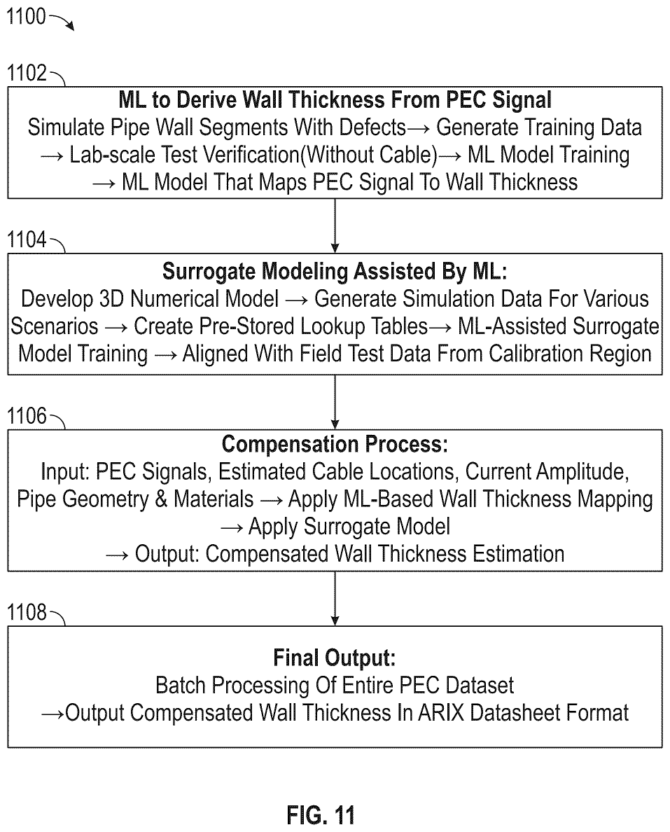

FIG. 11 is a flow diagram of a method 1100 for perform completion including surrogate modeling and machine learning according to one or more embodiments. The method 1100 can be performed by or using any of the systems, devices, and/or components described herein.

At block 1102, the trained model 719 is trained to derive wall thickness from the metal loss output measurements 210 from the PEC problem 206. This includes simulating pipe wall segments with defects, generating training data, performing lab-scale test verification (without cable), and performing ML model training (e.g., training 702) to generate the trained model 719 that maps the metal loss output measurements 210 (e.g., PEC signals) to wall thickness.

At block 1104, surrogate modeling is performed with machine learning assistance. A 3D numerical model is developed, simulation data is generated for various scenarios, pre-stored lookup tables are generated, and ML-assisted surrogate model training is performed and aligned with field test data from calibration as described herein.

According to one or more embodiments, the alignment process is more sophisticated than a simple ratio calculation. While the basic scaling factor can be represented as

$$S = \frac{{τ}_{experiment}}{{τ}_{simulaton}} ,$$

advanced techniques can be applied to refine the alignment. This ensures that the simulated decay times are not only scaled correctly but also aligned accurately with the experimental data, accounting for various patterns and anomalies. Advanced statistical methods and machine learning algorithms can be employed to enhance the alignment accuracy. These techniques include, for example, regression analysis, neural network models, and optimization algorithms that minimized the difference between simulated and experimental decay times.

By integrating these advanced methods, a high level of accuracy is achieved in aligning the decay times. This step provides for ensuring that the PEC measurements accurately reflected the true condition of the pipeline, providing a reliable basis for further analysis and decision-making. The refined alignment also helps in detecting subtle variations in the material properties and external influences, which are useful for comprehensive pipeline integrity assessments.

The alignment process begins with local training on the calibration data. This involved refining the relationship between simulated decay times τₛᵢₘᵤₗₐₜᵢₒₙ and experimental decay times τₑₓₚₑᵣᵢₘₑₙₜ. By focusing on the calibration regions identified as described herein, it is provided that the model is accurately tuned to the actual conditions observed in the field.

Beyond simple scaling, the alignment process includes identifying specific patterns in the decay time data, such as double dipping and other anomalies. Recognizing these patterns is useful for accurately aligning the simulated data with the experimental results, ensuring that the model accounts for various observed phenomena. The double dip phenomenon, in particular, can be observed in limited cases and is hypothesized to be caused by localized variations in the magnetic field due to multiple cables positioned closely together, as illustrated in FIG. 1B, for example. Understanding this pattern allows for adjusting the model to account for these anomalies accurately.

At block 1106, a compensation process is performed. An input of PEC signals (the metal loss output measurements 210), estimated cable location(s), current amplitude, pipe geometry, and materials information are received. The ML-based wall thickness mapping described herein is then performed, and a surrogate model is applied as described herein. The results (output) are the compensated metal loss output measurements 214.

The compensated wall thickness calculation is now described in more detail, which provides for calculating and visualizing the compensated wall thickness, effectively adjusting for magnetic field distortions to provide accurate measurements of wall thickness of the pipe 104.

In the context of populating a lookup table using a Gaussian Process Regression (GPR) model, the mathematical representation can be described as follows. Suppose a dataset with input features X= {x₁, x₂, . . . , x_{N}}, where each xᵢ=(pipeODᵢ, pipeWTᵢ, Muᵢ, WTᵢ), and corresponding target values y={y₁, y₂, . . . , y_{N}}, where yᵢ represents the Tau value for the i^{th} sample. The GPR model learns a mapping f: X=→y, which can be represented as:

$${y}_{i} = f ( {x}_{i} ) + {ϵ}_{i}$$

where ϵᵢ is the noise or error term, assumed to be Gaussian with zero mean and variance of σₙ². The GPR model assumes that the function ƒ is a Gaussian Process (GP) with mean function μ(x) and covariance function k(x,x′):

$$f ( x ) ∼ 𝒢𝒫 ( μ ( x ) , k ( x , {x}^{′} ) ) .$$

The mean function μ(x) is assumed to be zero, and the covariance function k(x, x′) is the Radial Basis Function (RBF) kernel:

$$k ( x , {x}^{′} ) = {σ}_{f}^{2} exp ( - \frac{{‖ x - {x}^{′} ‖}^{2}}{2 {l}^{2}} )$$

where σ_{f}² is the signal variance. During training 702, the GPR model learns the hyperparameters θ={σ_{f}², l, σₙ²} by maximizing the log marginal likelihood:

$$log p ( y \vert X , θ ) = - \frac{1}{2} {y}^{T} {K}^{- I} y - \frac{1}{2} log \vert K \vert - \frac{N}{2} log 2 π$$

where K is the covariance matrix constructed using the kernel function k(x, x′) and the training inputs X. Once the GPR model is trained, it can be used to predict the Tau value for a new input x, as follows:

$${μ}_{*} = k ( {x}_{*} , X ) {K}^{- 1} y$$

$${σ}_{*}^{2} = k ( {x}_{*} , {x}_{*} ) - k ( {x}_{*} , X ) {K}^{- 1} k ( X , {x}_{*} )$$

where μ, is the predicted mean value of Tau, and σ_{*}² is the predicted variance, representing the uncertainty in the prediction. In the provided code, the GPR model is trained, and then used to predict the Tau values for a grid of input points (pipeOD, pipeWT,Mu,WT). The predicted Tau values, along with the corresponding input features, are stored in a lookup table (e.g., pandas DataFrame) for further use or analysis. Moreover, to enhance the model's robustness, incorporate data from the calibration region can be incorporated, which includes input from calibration region X_{calibration} and true wall thickness percentages y_{calibration}. This data is repeated and perturbed with noise to simulate real-world conditions: X₁=X_{calibration}+N(0, σ_{X}²) and y₁=y_{calibration}+N (0, σ_{y}²). The training process (e.g., training 702) involves combining this calibration data with simulated data from the lookup table, resulting in a comprehensive training dataset. This combined dataset (e.g., training data 712), denoted as {X_{combined}, y_{combined}}, ensures that the surrogate model captures both the true underlying patterns and the uncertainties associated with real-world measurements. The combined data can be scaled using standard scalers and the GPR model is trained with an RBF kernel. The trained surrogate model is used to predict Tau values for a grid of input points (pipeOD,pipeWT,Mu,WT), with the predicted Tau values stored in a lookup table for further analysis. This surrogate model leverages the power of GPR to provide accurate and efficient predictions of PEC responses, eliminating the need for repeated computationally expensive simulations and facilitating quick assessments of material integrity under various conditions.

At block 1108, a final output is generated by batch processing the PEC dataset. This provides an output of compensated wall thickness in a datasheet format, although other formats are possible as described herein. The process begins with utilizing the aligned decay times obtained at block 1106. These decay times, refined through local training on calibration data and advanced alignment techniques, serve as the foundation for the compensation calculation. By leveraging these aligned decay times, the wall thickness measurements are adjusted to account for distortions caused by external magnetic fields, particularly those induced by nearby current-carrying cables (e.g., the cables 106a, 106b, 106c). The compensated wall thickness model is designed to address these magnetic field distortions, ensuring that the measurements accurately reflected the true material integrity of the pipeline. This adjustment is useful as magnetic field interferences can significantly distort the Pulsed Eddy Current (PEC) signals, leading to inaccurate assessments of wall thickness and material condition. By incorporating the effects of these distortions into the model, the reliability and accuracy of PEC measurements is improved. Mathematically, the compensated wall thickness is expressed as follows:

$${WT}_{compensated} = \frac{\begin{matrix}Compensated Wall Thickness Model \\ ( pipeOD , pipeWT , {μ}_{r} , {τ}_{experiment} )\end{matrix}}{scaling factor} .$$

The foregoing equation highlights the components involved in the compensation calculation. The model takes into account the OD of the pipe 104, the wall thickness of the pipe 104 relative permeability ur, and the experimentally observed decay time τₑₓₚₑᵣᵢₘₑₙₜ. These parameters were used to accurately predict the wall thickness while compensating for the distortions caused by the external magnetic fields. The scaling factor plays a role in this model by representing the ratio between the experimental decay time and the simulated decay time, ensuring that the adjustments are proportional and precise. By dividing the predicted wall thickness by this scaling factor, the model provides a highly accurate representation of the actual wall thickness of the pipe 104, adjusted for any distortions caused by the cables 106a, 106b, 106c.

The advanced techniques applied during the alignment process, including regression analysis and optimization algorithms, provide for the decay times to not only be scaled correctly but also to be aligned accurately with the experimental data. This refinement is useful for detecting subtle variations in the material properties and external influences, enhancing the overall accuracy of the compensated wall thickness measurements. Overall, the compensated wall thickness model, by integrating these comprehensive adjustments and refinements, provides a robust and reliable approach to assessing pipeline integrity in the presence of magnetic field distortions. This approach ensures that the measurements accurately reflect the true condition of the pipe 104, offering a reliable basis for further analysis and decision-making in pipeline integrity assessments.

It will be appreciated that one or more embodiments described herein may be embodied as a system, method, or computer program product and may take the form of a hardware embodiment, a software embodiment (including firmware, resident software, micro-code, etc.), or a combination thereof. Furthermore, one or more embodiments described herein may take the form of a computer program product embodied in one or more computer readable medium(s) having computer readable program code embodied thereon.

One or more embodiments may be a system, a method, and/or a computer program product at any possible technical detail level of integration. The computer program product may include a computer-readable storage medium (or media) having computer-readable program instructions thereon for causing a processor to carry out aspects described herein.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations described herein may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects described herein.

Aspects are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects are described herein with reference to the related drawings. Alternative aspects can be devised without departing from the scope set forth by the claims. Various connections and positional relationships (e.g., over, below, adjacent, etc.) are set forth between elements in the following description and in the drawings. These connections and/or positional relationships, unless specified otherwise, can be direct or indirect, and are not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. As used herein, the singular forms “a”, “an” and “the” are intended to include the plural forms as well, unless the context clearly indicates otherwise. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of +8% or 5%, or 2% of a given value.

For the sake of brevity, conventional techniques related to making and using aspects described herein may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general-purpose microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

What is claimed is:

1. A method of pulsed eddy current (PEC) testing, the method comprising:
receiving metal loss output measurements, the metal loss output measurements calculated based on an eddy current response captured by a probe at a location on a pipe or tank, wherein one or more energized high voltage cables are located within the pipe or tank;
generating compensated metal loss output measurements to compensate for errors in the metal loss output measurements caused by the energized high voltage cables; and
outputting the compensated metal loss output measurements as PEC test results.

2. The method of claim 1, further comprising controlling the movement of the probe to another location on the pipe or tank.

3. The method of claim 1, further comprising creating eddy currents by causing an electrical current to be supplied to the probe and causing the electrical current to be cut-off from the probe.

4. The method of claim 3, further comprising calculating the metal loss output measurements based at least in part on the eddy currents.

5. The method of claim 1, wherein the pipe or tank comprises a ferrous material.

6. The method of claim 1, wherein the PEC test results indicate an estimated average thickness of the pipe or tank at the location.

7. The method of claim 1, wherein the outputting is to one or both of a storage device and a user interface.

8. The method of claim 1, wherein the PEC results are expressed as a percentage of thickness of a wall of the pipe or tank relative to a nominal thickness.

9. A system for pulsed eddy current (PEC) testing, the system comprising:
a PEC tester configured to collect a plurality of metal loss output measurements at various locations of a pipe or tank made up of a ferrous material, wherein one or more energized high voltage cables are located within the pipe or tank; and
a processing system comprising:
a memory comprising computer readable instructions; and
a processing device for executing the computer readable instructions, the computer readable instructions controlling the processing device to perform operations comprising:
receiving the metal loss output measurements;
generating compensated metal loss output measurements to compensate for errors in the metal loss output measurements caused by the energized high voltage cables; and
outputting the compensated metal loss output measurements as PEC test results.

10. The system of claim 9, wherein the operations further comprise controlling the movement of the PEC tester to another location on the pipe or tank.

11. The system of claim 9, wherein the operations further comprise creating eddy currents by causing an electrical current to be supplied to the PEC tester and causing the electrical current to be cut-off from the PEC tester.

12. The system of claim 11, wherein the operations further comprise calculating the metal loss output measurements based at least in part on the eddy currents.

13. The system of claim 9, wherein the pipe or tank comprises a ferrous material.

14. The system of claim 9, wherein the PEC test results indicate an estimated average thickness of the pipe or tank at the location.

15. The system of claim 9, wherein the outputting is to one or both of a storage device and a user interface.

16. The system of claim 9, wherein the PEC results are expressed as a percentage of thickness of a wall of the pipe or tank relative to a nominal thickness.

17. A machine learning system, comprising:
a memory comprising computer readable instructions; and
a processing device for executing the computer readable instructions, the computer readable instructions controlling the processing device to perform operations comprising:
receiving training data as input, the training data comprising pulsed eddy current (PEC) measurements from field tests, simulated data from finite element modeling simulations, and pipe profiles from field testing;
preprocessing the training data by performing feature extraction on the PEC measurements, data normalization, and scaling; and
generating a trained machine learning model using results of the preprocessing of the training data, the trained machine learning model taking as input at least meat loss output measurements from a PEC tester and generated compensated metal loss output measurements.

18. The machine learning system of claim 17, wherein generating the trained machine learning model comprises mapping an artificial intelligence-based surrogate model relative permeability and magnetic field strengths to features extracted from the PEC measurements.

19. The machine learning system of claim 17, wherein generating the trained machine learning model comprises aligning features extracted from simulation and field test data.

20. The machine learning system of claim 17, wherein generating the trained machine learning model comprises fine tuning the trained machine learning model using additional field test data.
